(19) United States
(12) Patent Application Publication
(10) Pub. No.: US 2017/0368714 A1
(43) Pub. Date: Dec. 28, 2017

(54) Method for Manufacturing a Continuous Drill Ring for a Core Drill Bit

(71) Applicant: Hilti Aktiengesellschaft, Schaan (LI)

(72) Inventors: Matthias Mueller, Buchs (CH); Marcel Sonderegger, Balgach (CH)

(73) Assignee: Hilti Aktiengesellschaft, Schaan (LI)

(21) Appl. No.: 15/538,574

(22) PCT Filed: Dec. 22, 2015
(86) PCT No.: PCT/EP2015/080903

§ 371 Date: Jun. 21, 2017

(30) Foreign Application Priority Data
Dec. 22, 2014 (EP) 14199721.3

(51) Int. Cl. B28D 1/04; B28D 1/12; B28D 1/14; B23D 61/18; B23P 15/28

(52) U.S. Cl. CPC B28D 1/041; B28D 1/146; B23D 61/18; B28D 1/121; B23P 15/28

(57) ABSTRACT

A method for manufacturing a continuous drill ring for a core drill bit is disclosed. The method includes forming at least two green compacts in layers in a direction of formation between a bottom side and a top side by successively applying powder layers containing a powder mixture and diamond layers containing diamond particles that are arranged in a set pattern, shaping the green compacts into ring segments under the effect of pressure, sintering the ring segments under the effect of heat, and combining the sintered ring segments in a circular manner and joining the same in a frictionally engaging or integrally bonding manner at the lateral edges thereof so as to obtain the continuous drill.

This application claims the priority of International Application No. PCT/EP2015/080903, filed Dec. 22, 2015, and European Patent Document No. 14199721.3, filed Dec. 22, 2014, the disclosures of which are expressly incorporated by reference herein.

### BACKGROUND AND SUMMARY OF THE INVENTION

The present invention relates to a method for manufacturing a continuous drill ring for a core drill bit.

In regard to diamond tools that are designed as core drill bits, one differentiates between core drill bits with a continuous drill ring and segmented core drill bits with individual cutting segments. Core drill bits consist of a cutting section, a cylindrical drill shank and a receiving section with an insertion end. The core drill bit is attached via the insertion end in the tool chuck of a core drilling device, and in drilling operations is driven by a core drill device about a rotation axis.

Continuous drill rings are manufactured from a powder mixture with statistically distributed diamond particles. The powder mixture is filled into a tool mold and pressed into a green compact; the green compact is sintered under the effects of temperature and pressure into a continuous drill ring. U.S. Pat. No. 5,316,416 discloses the structure of continuous drill rings, which have good removal properties over the entire height of the drill ring. The drill rings have multiple upper slits and lower slits, which are distributed along the peripheral direction of the drill rings. The upper slits extend over half the height of the drill rings and lead to the machining surface, facing away from the drill shank, of the drill rings. The lower slits are arranged in each case between the upper slits along the peripheral direction of the drill rings and lead to the joining surface, facing the drill shank, of the drill rings. The upper and lower slits overlap in the height of the drill rings. Through the distribution of the upper and lower slits over the entire height of the drill rings, a cooling and flushing liquid is carried to the cutting location during the entire operating period of the drill ring and removed material is taken away from the drilling region.

Regarding the manufacture of cutting segments for segmented core drill bits, methods have established themselves in the profile region, in which the diamond particles are arranged in a specified placement pattern. A green compact is formed in layers out of powder layers, which contain a powder mixture and diamond layers with diamond particles arranged in a placement pattern, and is then sintered under the effects of temperature and pressure into a cutting segment. The cutting segments are arranged along a peripheral direction of the cylindrical drill shank and welded, soldered or otherwise attached to the drill shank. The cutting speed, which can be achieved with a segmented core drill bit, depends to a large extent on the arrangement of diamonds in the cutting segment. In the layer-wise formation, the arrangement of the diamond particles can be influenced by the number of diamond layers, the distance between the diamond layers, and the size of the diamond particles.

The object of the present invention is to apply the technology of placed diamonds on continuous drill rings and to increase the cutting quality that can be achieved with drill rings manufactured in this manner.

This task is achieved by the method mentioned in the beginning for manufacturing a continuous drill ring for a core drill bit according to the invention.

The method according to the invention for manufacturing a continuous drill ring comprises the steps of:
at least two green compacts are formed layer-wise in a formation direction by the successive application of powder layers of a powder mixture and diamond layers containing diamond particles, which are arranged in a set pattern, between a bottom side and a top side,
the green compacts are shaped into ring segments under the effect of pressure,
the ring segments are sintered under the effect of temperature, and
the sintered ring segments are combined in a ring-shaped manner and joined at the side edges in a frictionally engaging or integrally bonding manner to obtain a continuous drill ring.

The method according to the invention comprises a plurality of process steps that utilize various technologies. In the first process step, a plurality of green compacts are formed layer-wise out of powder layers containing a powder mixture and diamond layers containing diamond particles. The term “powder mixture” refers to fine-grained powder mixtures and granulated powder mixtures; the use of granulated powder mixtures is a prerequisite for volumetric cold pressing. One can use iron, cobalt and/or bronze powder as the powder mixture; by mixing in additives, such as wolfram carbide, one can influence the properties of the drill rings (wear resistance, service life, cutting performance). In addition, the composition of the powder mixture has an influence on the sintering temperature. The term “diamond particles” refers to individual diamond particles as well as encased or coated diamond particles.

After the layer-wise formation, the green compacts have the geometric shape of a straight prism with a polygonal base surface. In the second method step, the prism-shaped green compacts are shaped into ring segments under the effect of pressure. The forming of the green compacts occurs at temperatures that are below the melting temperature of the powder mixture. Cold pressing, hot pressing, and comparable processes are suitable as forming processes. In cold pressing, a green compact is brought into the specified form under high pressure. In a cold press, the material does heat up, but the forming takes place in a temperature range in which recrystallization does not occur; the material deforms without the strength decreasing significantly. In hot pressing, which is also referred to as drop forging, a green compact is brought to its final shape under high pressure and the addition of heat. Besides the shape, the forged piece changes its material structure; it becomes stronger and thereby obtains a denser structure and a homogeneous surface.

In a third method step, the ring segments are sintered under the effect of temperature; during sintering, a compression of the individual ring segments occurs. In the fourth method step, the sintered ring segments are combined in a circular manner and joined at the side edges in a frictionally engaging or integrally bonding manner to obtain a continuous drill ring. All conventional joining processes, such as welding, soldering, adhesive bonding, and comparable joining processes, are suitable as methods for the friction-engaging or material-bonding joining of the side edges.

Sintering is a method for manufacturing materials, in which a powder or a green compact (compressed powder) is heated to temperatures below the melting temperature to increase the strength by bonding the individual particles. The sintering process occurs in three stages, in which the porosity and the volume of the green compact are significantly decreased. In the first sintering stage, only a compression of the green compact occurs, whereas in the second stage, the open porosity is significantly decreased. The strength of the sintered bodies is based on the sintered bonds (fusing between powder particles) formed in the third stage, which result from surface diffusion between the powder particles.

In the method according to the invention, the drill ring is not formed as a continuous drill ring, but is combined from two or more ring segments, which are joined to each other at the side edges in a frictionally engaging or integrally bonding manner. In the layer-wise formation of the green compacts, known technologies are used in manufacturing cutting segments for segmented core drill bits.

In a preferred development, the ring segments are subjected to the effects of temperature and pressure while sintering. The forming of the green compacts into ring segments and the subsequent sintering of the ring segments can be carried out in a joint process step. Hot pressing is a special sintering process in which, besides temperature, external pressure is also applied. The green compacts are simultaneously shaped in a hot press through the effect of pressure and sintered by the effect of temperature. In sintering processes occurring under the effects of temperature and pressure, such as hot pressing, sintering occurs faster and at lower temperatures than in sintering processes without the effect of pressure, such as free sintering. Since thermal diamond damage already occurs at 600° C., a lower sintering temperature may be a qualitative advantage.

In a particularly preferred manner, the pressure effect during sintering subjects the ring segments to an additional external shaping. For working on various substrates, special prismatic shapes have proven to be suitable. These prismatic shapes may be produced by the effect of pressure during sintering.

In a preferred variant of the method, the drill ring is formed out of a number of n, n≧1 first green compacts that are shaped into the first ring segments, and n second green compacts that are shaped into the second ring segments, wherein the first and second ring segments are arranged along a peripheral direction of the drill ring alternately in succession. Manufacturing the drill ring from first and second green compacts allows one to adapt the drill ring to various substrates to be worked on. For core drilling into concrete materials with embedded reinforcing bars, which are also referred to as reinforced concrete materials, a drill ring may encounter for example various substrates in the form of concrete and reinforcing bars.

In a particularly preferred manner, the first ring segments are formed of a first powder mixture and first diamond particles, and the second ring segments are formed of a second powder mixture and second diamond particles. One can adapt the drill ring to the substrate to be worked by selecting the powder mixture and the diamond particles. For the powder mixture, one can vary the composition of the materials; for diamond particles, one can vary the average diamond diameter, the diamond distribution, and the number of diamond particles.

In an alternative preferred variant of the method, the drill ring is formed of a number of 2n, n≧1 identical green compacts, wherein n green compacts are formed under the effect of pressure into first ring segments having a convex curvature, and n green compacts are shaped under the effect of pressure into second ring segments having a concave curvature. By using the same green compacts, the apparatus-related expense of the layer-wise formation of green compacts can be reduced; one only needs one powder mixture and one type of diamond particles.

In a particularly preferred manner, for the first ring segments, the top side of the green compacts is arranged on the exterior side and for the second ring segments, they are arranged on the interior side, wherein the first and second ring segments are arranged along a peripheral direction of the drill ring in an alternating successive manner. Due to the variable curvature of the ring segments, one can manufacture two different ring segments from the same green compacts. The green compacts have on the top side a diamond layer, which for the first ring segments is arranged on the exterior surface, and which for the second ring segments is arranged on the interior surface.

In a particularly preferred manner, the number of diamond layers and the size of the diamond particles are adjusted in such a manner that the average diamond diameter of the diamond particles is at least 45% of the ratio of the drill ring width to the number of diamond layers. For cutting reinforced concrete materials, it has proven itself to be advantageous if the circular removal paths that the diamond particles generate during cutting preferably adjoin each other, and the reinforcing bars are almost entirely ablated by the diamond particles. The number of removal paths that the diamond particles generate during cutting may be doubled by the alternating arrangement while keeping the number of diamond particles the same.

After the layer-wise formation, the green compacts have the geometric shape of a straight prism with a polygonal base surface. Rectangular, pentagonal, and hexagonal base surfaces are suitable as polygonal base surfaces.

In a first variant, the green compacts are formed of powder layers with rectangular base surfaces. The rectangular base surface represents the simplest geometry to manufacture drill rings out of multiple ring segments. The ring segments are joined at the side edges using the adjoining ring segments.

In a second variant, the green compacts are formed of powder layers with pentagonal base surfaces, wherein the base surfaces have a rectangle and a trapezoid with two right interior angles. In the region of the inclined trapezoid size, a water slit is produced with the neighboring ring segment during sintering. With such a pentagonal base surface, a number of n water slits is produced on a drill ring having 2n, n≧1 ring segments.

In a third variant, the green compacts are formed out of powder layers with hexagonal base surfaces, wherein the green compacts have a rectangle and an even-sided trapezoid. In the region of the inclined trapezoid sides, water slits are produced with the neighboring ring segments during sintering. With such a hexagonal base surface, a number of n water slits is produced on a drill ring having n, n≧2 ring segments.

In a particularly preferred manner, the height of the trapezoid is set to between ⅓ and ⅚ of the total height of the green compact. For drill rings, which are welded to the drill shank, the attachment region is formed without diamonds and is unsuited for cutting. The matrix zone equipped with diamond particles is suitable for cutting substrates, the zone representing approx. ⅚ of the total height of the green compact. In a particularly preferred manner, the height of the trapezoid is set to ⅔ of the total height of the green compact. At ⅔ of the total height, sufficient rigidity of the completed drill ring can be ensured. While cutting with the drill ring, cooling fluid must be carried to the cutting location; therefore, the water slits in the drill ring are designed to be as long as possible.

Embodiments of the invention are described below by means of the drawings. It is intended to show the embodiments not necessarily to scale; rather the drawings, where useful for explanation purposes, are executed in a schematic and/or slightly distorted manner. Regarding amendments to the teachings directly evident from the drawings, one shall refer to the relevant prior art. In doing so, one shall take into account that diverse modifications and changes pertaining to the form and detail of an embodiment can be undertaken without departing from the general idea of the invention. The features of the invention disclosed in the description, drawings and claims may be essential both individually on their own as well as in any combination for the further development of the invention. Also falling within the scope of the invention are all combinations of at least two of the features disclosed in the description, drawings and/or claims. The general idea of the invention is not restricted to the exact form or detail of the preferred embodiments depicted and described hereafter, or limited to a subject matter that would be restricted in comparison to the subject matter claimed in the claims.

For given measurement ranges, values lying within the mentioned limits shall be disclosed as limit values and one shall be able to use and claim these as one wishes. For the sake of simplicity, the same reference signs are used for identical or similar parts, or parts with an identical or similar function.

### BRIEF DESCRIPTION OF THE DRAWINGS

FIG. 1 depicts a core drill bit consisting of a drill ring, a cylindrical drill shank, and a receiver section;

FIGS. 2A-C depict a first embodiment of a drill ring according to the invention, which is formed of four ring segments, in a three-dimensional illustration (FIG. 2A), in a cross-section perpendicular to the cylinder axis of the drill ring (FIG. 2B), and in a detail enlargement (FIG. 2C);

FIG. 3 depicts a second embodiment of a drill ring according to the invention, which is formed of four ring segments with water slits;

FIGS. 4A-C depict the manufacture of the drill ring of FIG. 3 out of four identical green compacts with a hexagonal base surface (FIG. 4A), wherein two green compacts are formed and sintered into concave first ring segments and two green compacts are formed and sintered into convex second ring segments (FIG. 4B), and the sintered ring segments are arranged along a peripheral direction in an alternating successive manner and are joined at the side edges in a frictionally engaging or integrally bonding manner to obtain a continuous drill ring (FIG. 4C); and

FIGS. 5A-C depict green compacts with a rectangular base surface (FIG. 5A), a pentagonal base surface (FIG. 5B) and a hexagonal base surface (FIG. 5C).

### DETAILED DESCRIPTION OF THE DRAWINGS

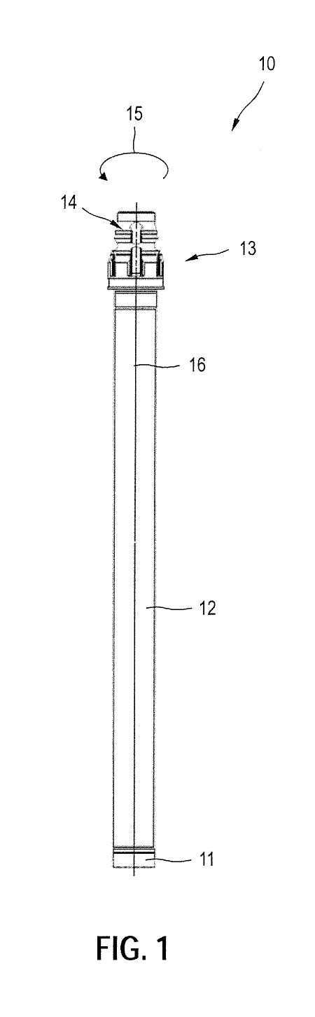

FIG. 1 depicts a core drill bit 10 with a drill ring 11, a cylindrical drill shank 12, and a receiver section 13 with insertion end 14. Core drill bit 10 is attached via insertion end 14 in the tool chuck of a core drill device and in drilling operations, it is driven by the core drill device in a rotation direction 15 about a rotation axis 16, wherein rotation axis 16 runs coaxially to the cylinder axis of core drill bit 10.

Drill ring 11 is welded, soldered, or screwed to drill shank 12, or attached by some other suitable attachment method to drill shank 12. To weld drill ring 11 to drill shank 12, the joining region between drill ring 11 and drill shank 12 must be formed of a weldable material and may not contain any diamond particles, since diamond particles are not weldable.

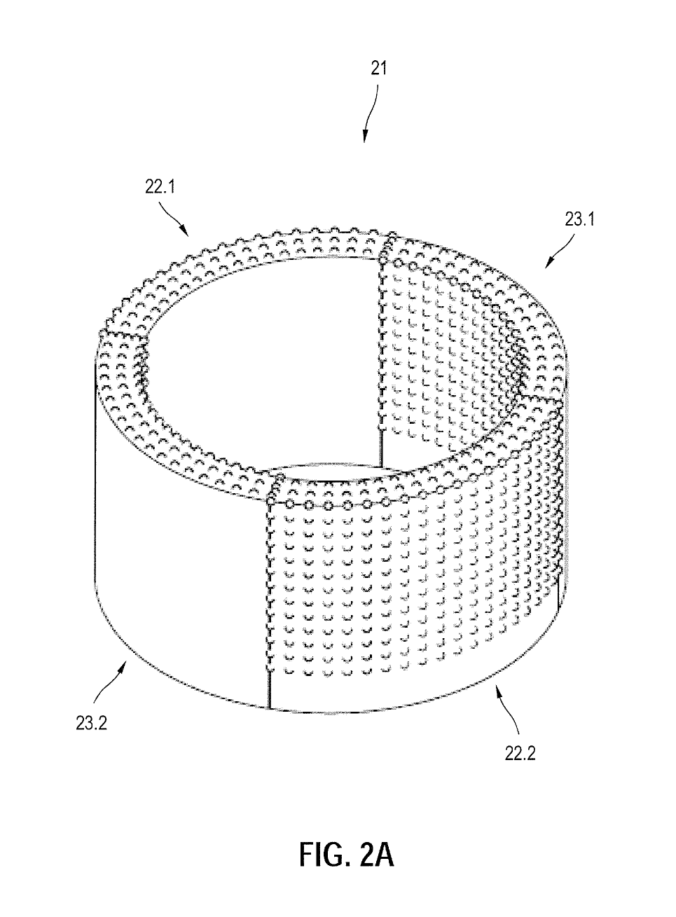

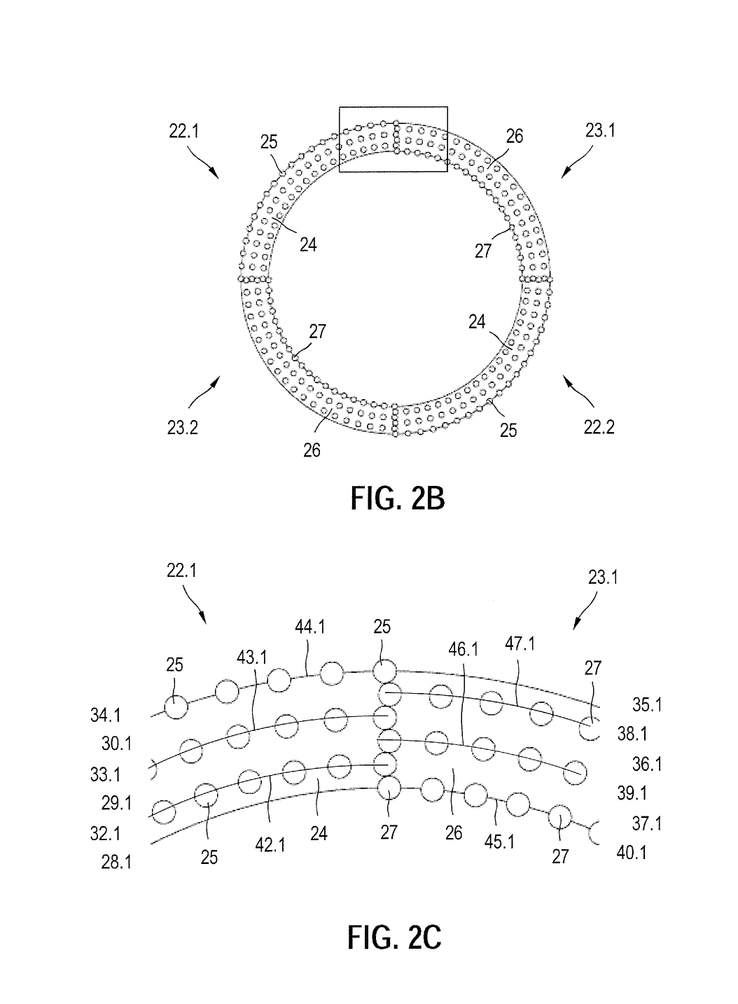

FIGS. 2A-C depict a first embodiment of a drill ring 21 according to the invention, which is composed of multiple ring segments and can replace drill ring 11 of core drill bit 10 of FIG. 1. FIG. 2A thus depicts drill ring 21 in a three-dimensional view; FIG. 2b depicts drill ring 21 in a cross-section perpendicular to rotation axis 16; and FIG. 2C depicts a section from the cross-section of FIG. 2B in the joining region between two ring segments.

Drill ring 21 is composed of four ring segments, which are joined to each other at the side edges and form a continuous ring in the peripheral direction (FIG. 2A). The ring segments of drill ring 21 can be subdivided into two first ring segments 22.1, 22.2, and two second ring segments 23.1, 23.2, which are arranged along the peripheral direction of drill ring 21 in an alternating successive manner. First ring segments 22.1, 2.2 consist of a first powder mixture 24 and first diamond particles 25; and second ring segments 23.1, 23.2 consist of a second powder mixture 26 and second diamond particles 27 (FIG. 2B).

FIG. 2C depicts a section of the cross-section from FIG. 2B in the joining region between first ring segment 22.1 and second ring segment 23.1. First ring segment 22.1 is formed of a number of m₁ powder layers of first powder mixture 24 and m₁ diamond layers of first diamond particles 25. Second ring segment 23.1 is formed of a number of m₂ powder layers of second powder mixture 26 and m₂ diamond layers of second diamond particles 27. In the embodiment of FIG. 2, first ring segment 22.1 has m₁=3 powder layers 28.1, 29.1, 30.1 and m₁=3 diamond layers 32.1, 33.1, 34.1; and second ring segment 23.1 has m₂=3 powder layers 35.1, 36.1, 37.1 and m₂=3 diamond layers 38.1, 39.1, 40.1.

First diamond particles 25 of diamond layers 32.1-34.1 are arranged on three circular first removal paths 42.1, 43.1, 44.1 having various first curvature radii R₁ᵢ, i=1, 2, 3. Second diamond particles 27 of diamond layers 38.1-40.1 are arranged on three circular second removal paths 45.1, 46.1, 47.1 having various second curvature radii R₂ᵢ, i=1, 2, 3. Selecting the materials for the first and second powder mixture 24, 26, selecting the diamond distribution and size for first and second diamond particles 25, 27, and the number m₁, m₂ of the diamond layers and removal paths enable one to adapt drill ring 21 to various substrates to be machined.

Ring segments 22.1, 22.2, 23.1, 23.2 are formed layer-wise from three powder layers and three diamond layers. In the layer-wise formation, the powder mixture is filled into a die and forms the first powder layer. The diamond particles are placed in a placement pattern as the first diamond layer on or in the first powder layer. To compress the layer structure, an interim compression may occur after placing the diamond particles. Subsequently, the powder mixture is filled into the die and forms the second powder layer. The diamond particles are placed in a placement pattern as the second diamond layer on or in the second powder layer. This process is repeated until the desired formation height of the green compact is achieved. A diamond layer is used as the last layer.

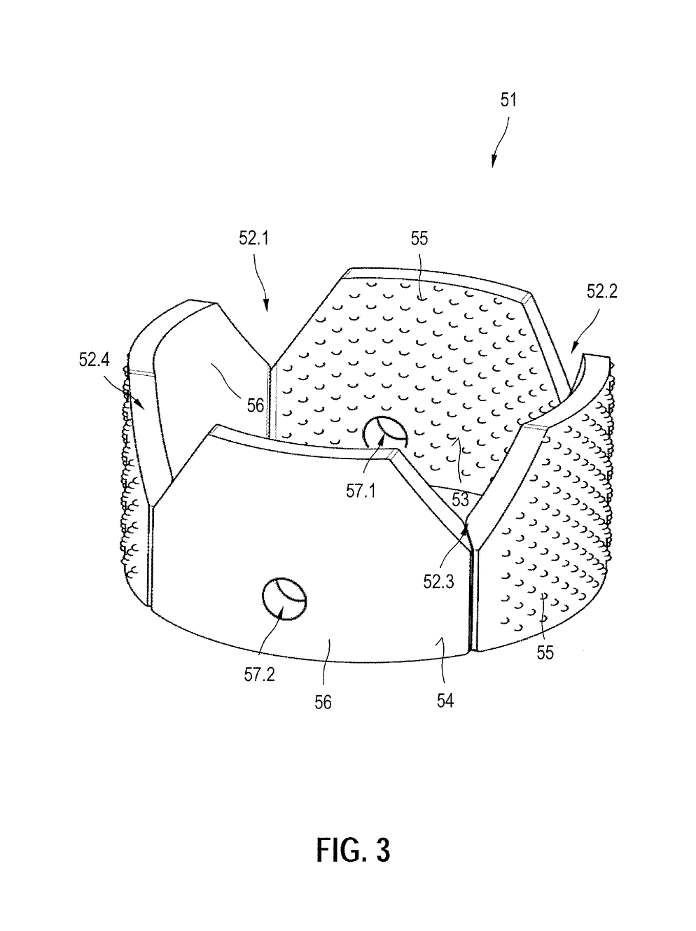

FIG. 3 depicts a second embodiment of a drill ring 51 according to the invention, which consists of four ring segments and can replace drill ring 11 of core drill bit 10. Between the ring segments, there are designed four water slits 52.1, 52.2, 52.3, 52.4, by means of which a cooling fluid can be carried to the cutting location. The ring segments are arranged in such a manner that drill ring 51 has diamond-studded region 55 and a diamond-less region 56 in an alternating manner on interior side 53 and on exterior side 54.

Water slits 52.1-52.4 extend over a height of approx. ⅔ of the total height of drill ring 51. To ensure the functional capability of drill ring 51 when water slits 52.1-52.4 are eroded, two ring segments have a hole 57.1, 57.2 by means of which cooling fluid can be carried to the machining location.

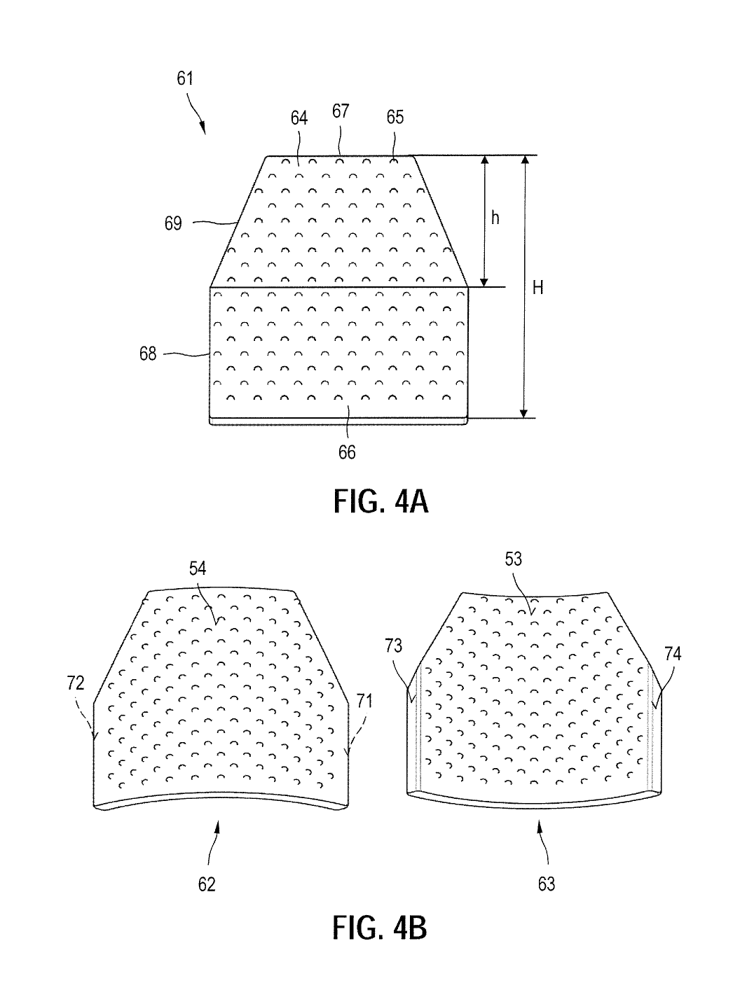

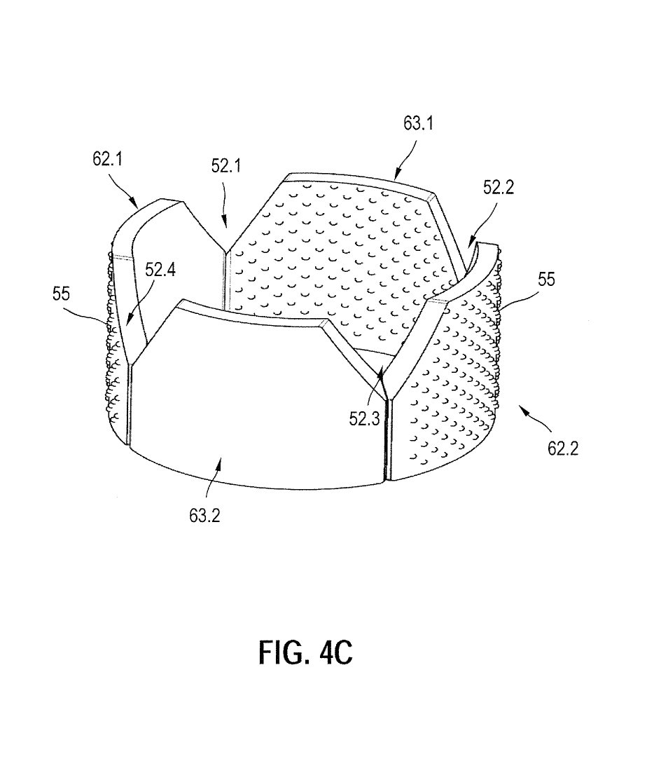

FIGS. 4A-C depict the manufacture of drill ring 51 from four identical green compacts 61 having a hexagonal base surface (FIG. 4A). Two green compacts 61 are formed and sintered into concave first ring segments 62 and two green compacts 61 are formed and sintered into convex second ring segments 63 (FIG. 4B). The sintered first and second ring segments 62, 63 are combined in a circular manner and joined at the side edges in a frictionally engaging or integrally bonding manner to obtain a continuous drill ring 51 (FIG. 4C).

FIG. 4A depicts the formation of green compact 61, which was manufactured in layer-wise manner out of powder layers of a powder mixture 64 and diamond layers of diamond particles 65. Green compact 61 consists of a joining region 66, which is also referred to as foot zone, and machining region 67, which is also referred to as matrix zone. Joining region 66 and machining region 67 may be formed jointly in a layer-wise manner, wherein no diamond particles 65 may be placed in the joining region. Alternatively, the joining region may be manufactured as a separate region, and it may be joined to the machining region during sintering.

The base surface of green compact 61 is designed in a hexagonal manner and consists of a rectangle 68 and an adjoining even-sided trapezoid 69, wherein joining region 66 of green compact 61 is situated in rectangle 68. In the region of the trapezoid sides, water slits 52.1-52.4, by means of which the cooling fluid is carried to the machining location, are formed during sintering by means of the additional application of pressure. Height h of trapezoid 69 in the green compress determines the height of water slits 52.1-52.4. In the embodiment, height h of trapezoid 69 corresponds to half the total height H of green compact 61.

FIG. 4B depicts first ring segment 62, which was produced with a convex curvature out of green compact 61 of FIG. 4A under the effects of temperature and pressure, and second ring segment 63, which was produced with a concave curvature out of green compact 61 of FIG. 4A under the effects of temperature and pressure. The effect of temperature ensures that powder mixture 64 sinters in ring segments 62, 63. By means of the effect of pressure in an axial direction, i.e., parallel to the cylinder axis of the drill ring, there results a compression of the ring segments, which leads to a compression of ring segments 62, 63. The hot pressing occurs in a die, which establishes the final shape of ring segments 62, 63.

For first ring segment 62, the top side of green compact 61, which is designed as a diamond layer, is arranged on exterior side 54, and for second ring segment 63, the top side of green compact 61 is arranged on interior side 53. Sintered first ring segment 62 has a first and second side edge 71, 72, which are joined to a first and second side edge 73, 74 of sintered second ring segment 63. In doing so, first side edge 71 of first ring segment 62 is joined to second side edge 74 of second ring segment 63, and second side edge 72 of first ring segment 62 is joined to first side edge 73 of second ring segment 63. For drill ring 51 having two first and second ring segments 62.1, 62.2, 63.1, 63.2, in each case the first and second side edges of adjoining ring segments are joined to each other.

FIG. 4C depicts first ring segments 62.1, 62.2 and second ring segments 63.1, 63.2, which are arranged along a peripheral direction of drill ring 51 in an alternating successive manner and are joined at the side edges in a frictionally engaging or integrally bonding manner. Ring segments 62.1, 63.1, 62.2, 63.2 form a continuous drill ring. All conventional joining processes, such as welding, soldering, adhesive bonding, and comparable joining methods are suitable as methods for frictional or integral bonding.

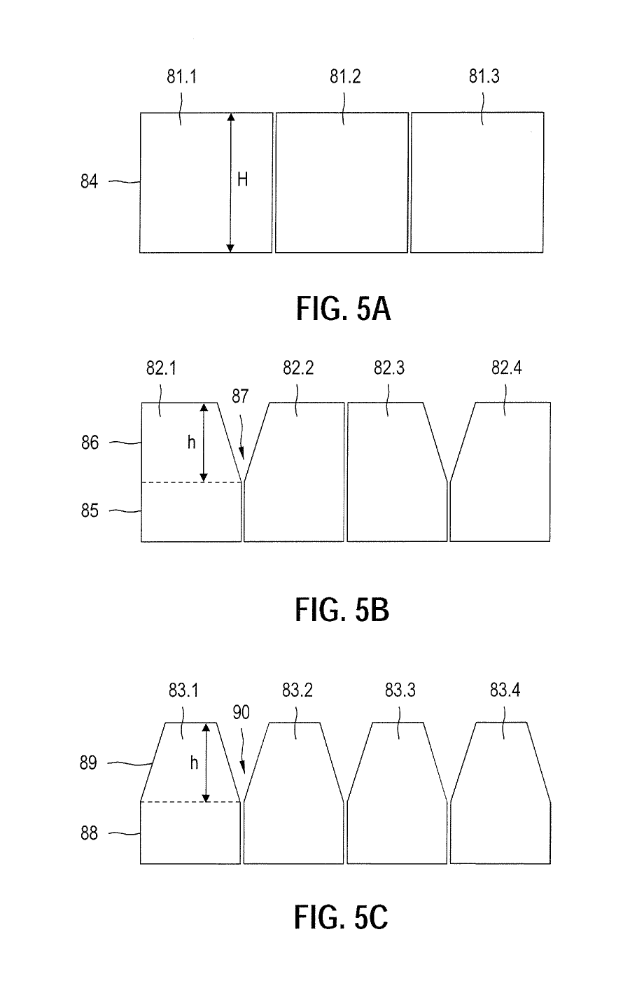

In the method according to the invention, a drill ring is formed of a plurality of green compacts, which are shaped into ring segments and sintered into a continuous drill ring; polygonal base surfaces are suitable as geometries for the green compacts. FIGS. 5A-C depict green compacts 81 having a rectangular base surface (FIG. 5A), green compacts 82 having a pentagonal base surface (FIG. 5B), and green compacts 83 with a hexagonal base surface (FIG. 5C).

Rectangular surface 84 of green compacts 81 represent the simplest geometry to manufacture drill rings from a plurality of ring segments. In the embodiment of FIG. 5A, three identical green compacts 81.1, 81.2, 81.3 are used to manufacture a continuous drill ring.

The pentagonal base surface of green compacts 82 can be subdivided into a rectangle 85 and a trapezoid 86 with two right interior angles. In the region of the slanted trapezoid side, a water slit 87 is produced with the adjoining ring segment during sintering. With such a pentagonal base surface, a number of n water slits 87 is produced on a drill ring having 2n, n≧1 ring segments.

The hexagonal base surface of green compacts 83 can be subdivided into a rectangle 88 and an equal-sided trapezoid 89. In the region of the slanted trapezoid sides, a water slit 90 is produced with the adjoining ring segment during sintering. With such a hexagonal base surface, a number of n water slits 90 is produced on a drill ring having n, n≧2 ring segments.

1.-12. (canceled)

13. A method for manufacturing a continuous drill ring for a core drill bit, comprising the steps of:
forming at least two green compacts by successive application of powder layers of a powder mixture and diamond layers having diamond particles;
forming the at least two green compacts under an effect of pressure into ring segments;
sintering the ring segments under an effect of temperature; and
assembling the sintered ring segments in a circular shape and joining the sintered ring segments to each other at respective side edges by frictional engagement or integral bonding to form the continuous drill ring.

14. The method according to claim 13, wherein the ring segments are subjected to an effect of pressure during the sintering.

15. The method according to claim 14, wherein the ring segments are externally shaped by the effect of pressure during the sintering.

16. The method according to claim 13, wherein the ring segments include first ring segments and second ring segments and wherein the first and the second ring segments are disposed along a peripheral direction of the continuous drill ring in an alternating successive manner.

17. The method according to claim 16, wherein the first ring segments are formed of a first powder mixture and first diamond particles and wherein the second ring segments are formed of a second powder mixture and second diamond particles.

18. The method according to claim 13, wherein the ring segments are formed from identical green compacts and wherein the ring segments include first ring segments having a convex curvature and second ring segments having a concave curvature.

19. The method according to claim 18, wherein a top side of the green compacts for the first ring segments is disposed on an exterior side and a top side of the green compacts for the second ring segments is disposed on an interior side and wherein the first and the second ring segments are arranged along a peripheral direction of the continuous drill ring in an alternating successive manner.

20. The method according to claim 19, wherein a number of diamond layers and a size of the diamond particles are adjusted such that an average diamond diameter of the diamond particles amounts to at least 45% of a ratio of a width of the continuous drill ring to the number of diamond layers.

21. The method according to claim 13, wherein the green compacts are formed of powder layers with rectangular base surfaces.

22. The method according to claim 13, wherein the green compacts are formed of powder layers with pentagonal base surfaces and wherein the base surfaces have a rectangle and a trapezoid with two right interior angles.

23. The method according to claim 13, wherein the green compacts are formed of powder layers with hexagonal base surfaces and wherein the base surfaces have a rectangle and an equal-sided trapezoid.

24. The method according to claim 22, wherein a height of the trapezoid is between ⅓ and ⅚ of a total height of the green compacts.
